(19) United States
(12) Patent Application Publication
(10) Pub. No.: US 2015/0252843 A1
(43) Pub. Date: Sep. 10, 2015

(54) PULLOUT GUIDE

(71) Applicant: PAUL HETTICH GMBH & CO. KG, Kirchlengern (DE)

(72) Inventors: Juergen Bachor, Kirchlengern (DE); Peter Jaehrling, Buende (DE); Daniel Rehage, Bielefeld (DE); Daniel Reidt, Herford (DE); Sebastian Bastkowski, Herford (DE); Edgar Frobieter, Hasbergen (DE); Matthias Kunsch, Hamburg (DE); Christian Koldewey, Bielefeld (DE)

(73) Assignee: PAUL HETTICH GMBH & CO. KG, Kirchlengern (DE)

(21) Appl. No.: 14/433,950

(22) PCT Filed: Oct. 1, 2013
(86) PCT No.: PCT/EP2013/070464

§ 371 Date: Apr. 7, 2015

(30) Foreign Application Priority Data
Oct. 12, 2012 (DE) 10 2012 109 757.7
Mar. 22, 2013 (DE) 10 2013 102 948.5

(51) Int. Cl. F16C 29/10; F16C 29/04

(52) U.S. Cl. CPC F16C 29/10; F16C 29/048; F16C 29/046

(57) ABSTRACT

A pullout guide for domestic appliances or furniture includes three rails mounted so they are movable in relation to one another, where a third rail is fixed on a body of the domestic appliance, a first rail is connected to a thrust element and a catch mechanism to latch the first rail in a predetermined position in relation to a second rail. A locking mechanism is provided to lock the second rail against a movement in relation to the third rail in the predetermined position.

The present invention relates to a pullout guide, in particular for domestic appliances or furniture, which comprises at least three rails mounted so they are movable in relation to one another, wherein one rail can be fixed on a body and one rail is connectable to a thrust element, and which comprises a catch mechanism, to latch a first rail in a predetermined position in relation to a second rail.

WO 2010/060724 discloses a pullout guide, in which catch means, are provided between the individual rails, which enable the movable slide rail to be latched in a pulled-out position. The catch elements comprise spring elements in this case, which can be fixed on corresponding catch recesses or projections. Latching the slide rail in one or more positions is possible using this arrangement, however, the catch forces can only be vaguely determined, because in particular in the case of a full pullout having at least three rails, two catch means are provided, wherein one of the two catch means must be disengaged to move the slide rail. It is not defined which catch means act with which catch force, so that high tolerances are present in the forces for movement out of the catch position. In addition, the problem exists that during the retraction or extension of the slide rail, latching in an intermediate position must be canceled, which is perceived as annoying during a continuous movement.

It is therefore the object of the present invention to provide a pullout guide which has a defined sequence control and in which the catch forces can be predefined.

This object is achieved with a pullout guide having the features of claim 1.

According to the invention, the pullout guide comprises a catch mechanism and a locking mechanism, wherein a first rail can be latched in a predetermined position in relation to a second rail via the catch mechanism and the second rail is locked against a movement in relation to a third rail in a predetermined position via the locking mechanism. Thus, in a pullout guide made of at least three rails, a sequence control is produced such that firstly the catch mechanism is disengaged, and then in a second step the locking mechanism is unlocked. The locking mechanism prevents a movement of the second rail in relation to the third rail from occurring in the predetermined position. The forces for disengaging the catch mechanism can therefore be set comparatively precisely, since only the tolerances of a single catch mechanism must be taken into consideration.

According to one preferred embodiment of the invention, the locking forces for locking the second rail in relation to the third rail are greater than the catch forces of the catch mechanism for latching the first rail on the second rail. For the subject matter of the present application, the catch mechanism and the locking mechanism can be constructed fundamentally similarly, wherein the locking mechanism require significantly higher unlocking forces, for example, at least 20% greater unlocking forces than the catch mechanism. A defined sequence control during the movement of the pullout guide may thus also be ensured.

According to a further embodiment, an unlocking element is provided, to unlock the locking mechanism and enable a movement of the second rail in relation to the third rail. Such an additional unlocking element prevents incorrect actuations in the pullout guide, wherein the unlocking element for the locking mechanism is preferably provided on the first rail. The unlocking element can then be moved together with the first rail, wherein a locking element is movable perpendicularly to the longitudinal direction of the rails via the unlocking element, for example. This enables a particularly reliable function of the pullout guide and unlocking which is nearly force-free and is almost imperceptible to the user.

For a simple mechanical embodiment of the locking mechanism, it can have a locking element which engages directly on the second or third rail. For example, the locking mechanism can comprise a pivotable lever, which is insertable with a projection into a recess on the second or third rail.

In an alternative embodiment, the locking mechanism has a locking element, which engages, for example, on a sliding element, a roller body cage, or a roller body between the second and the third rail. This enables a particularly compact structure, wherein the locking element can engage through a recess or opening in one of the rails to reach the roller body cage or the roller body. The locking element can be implemented in this case as a bendable lever, which has an actuating section, on which an unlocking element can engage. Unlocking of the locking mechanism can thus be performed using little force.

A stop is preferably provided on a bendable spring web of the locking element, to limit the maximum bending movement. This prevents a bendable spring web from being plastically deformed by an excess bending load and then protruding in an undesired manner from a rail. A bending movement of 2 mm to 6 mm is usually sufficient for the unlocking, so that stronger through bending can be prevented by the stop. Furthermore, an end of a spring web which can be lifted off of the rail can be implemented as bent, in particular, it can engage in a receptacle or recess on the rail. In this way, the end is prevented from being unintentionally lifted off of the rail during a cleaning operation. Such a bending safeguard can also be provided by a profile on the rail, so that the end of the spring web is arranged in a protected manner.

To enable a movement of the pullout guide out of the predetermined position, the catch mechanism preferably has a spring element, which is bent before reaching the predetermined position of the first and the second rails, to then engage behind a catch means. The catch means can be implemented on one of the rails, however, a sliding element, a roller body, or a projection or a recess on a roller body cage can also be used as the catch means, for example.

The roller bodies can have various geometries, for example, they can be embodied as spherical, in the form of rollers, or in the form of drums.

Catch and/or locking elements can be fixed in a friction-locked, form-fitting, or integrally-joined manner on the respective rail of the pullout guide.

To reduce tolerances, the catch mechanisms can have springs which are installed under pre-tension of the springs.

A fastening section can be enclosed by a relieving opening; A shape of the relieving opening can be dimensioned by ascertaining the tension curves inside the catch mechanism. Tension fractures are avoided by the introduction and implementation of the relieving opening.

The locking element, the locking mechanism, and/or the spring element of the catch mechanism are preferably produced from a metal plate or wire, so that the pullout guide is also usable at higher temperatures. The pullout guide is preferably used for displacing a cooked material carrier in an oven. The pullout guide can also be used, of course, in other domestic appliances, furniture, or other units for displaceable mounting of objects. The pullout guide can be sterilized in an autoclave and is therefore suitable for use in the medical field and in laboratories. Furthermore, the pullout guide is suitable for use in clean rooms.

The invention will be explained in greater detail hereafter on the basis of several exemplary embodiments with reference to the appended drawings. In the figures:

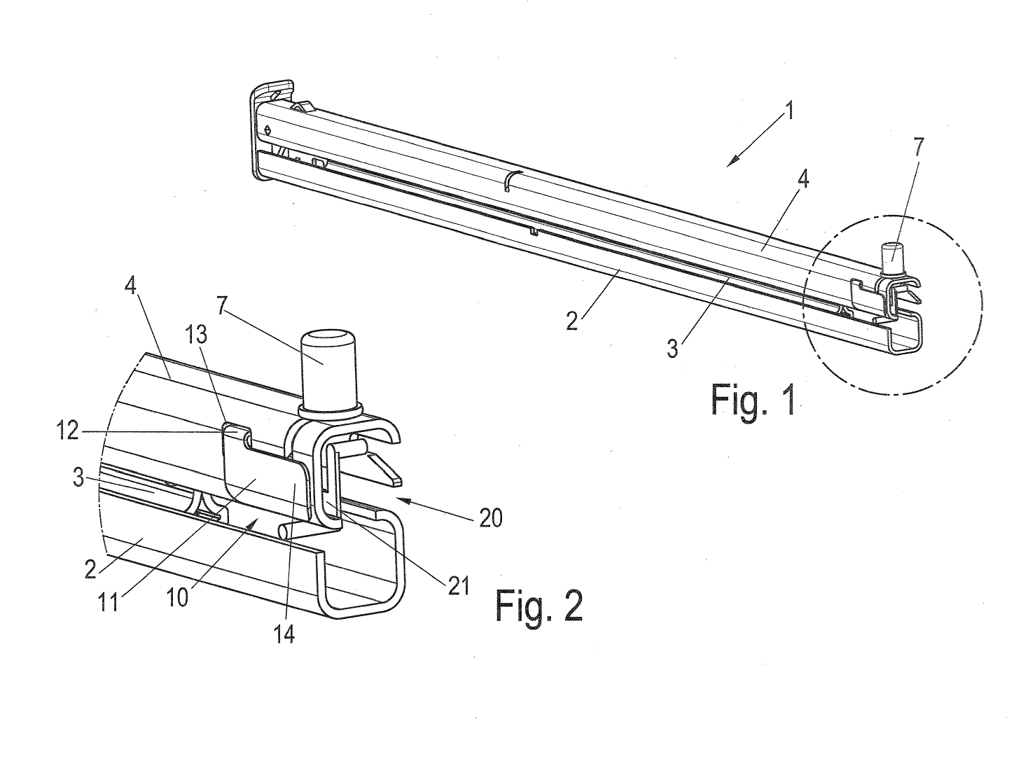

FIGS. 1 to 11 show multiple views of a first exemplary embodiment of a pullout guide according to the invention;

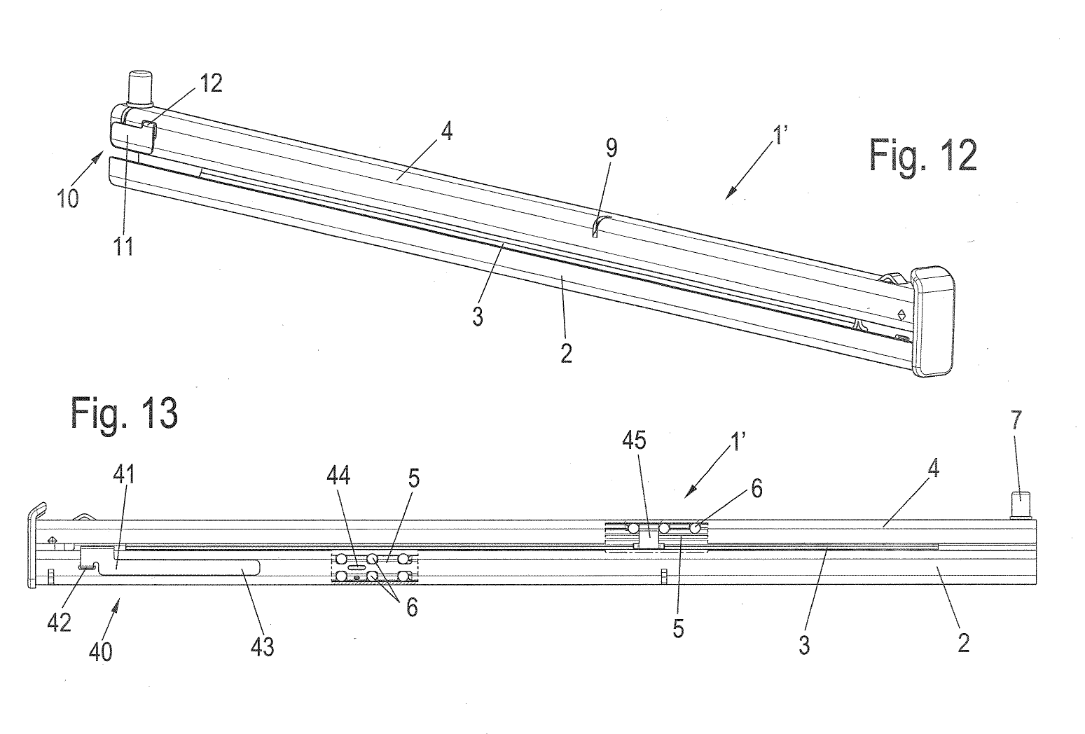

FIGS. 12 to 18 show multiple views of a second exemplary embodiment of a pullout guide according to the invention;

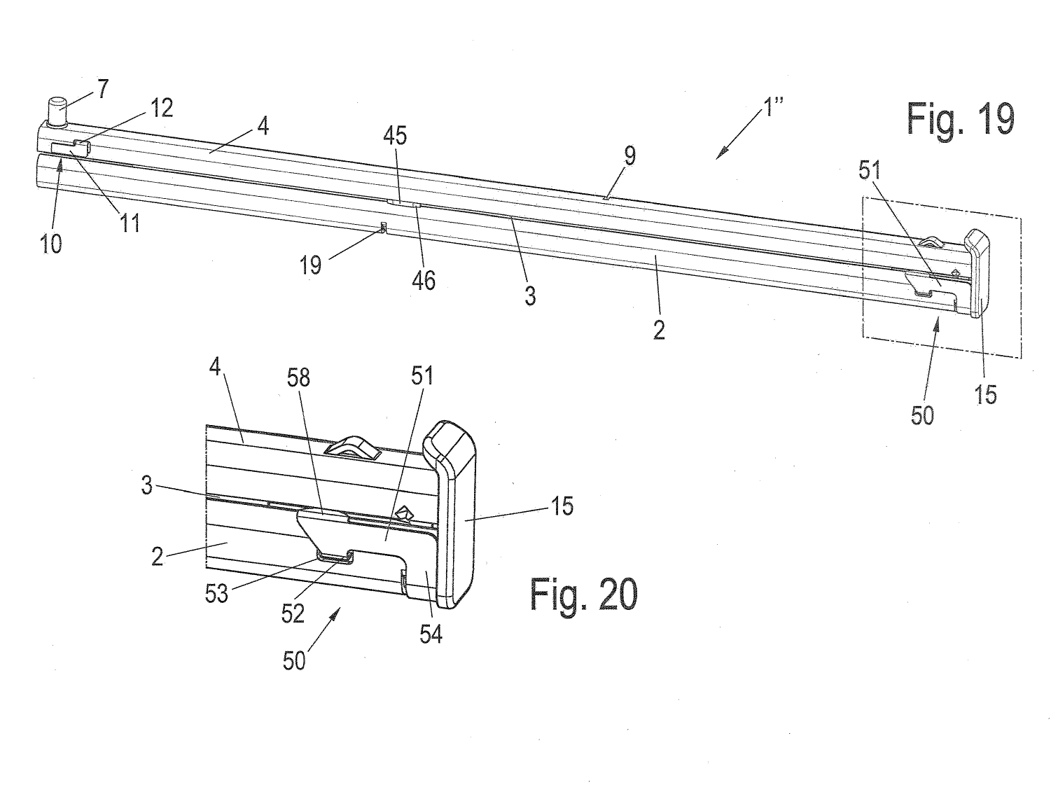

FIGS. 19 to 22 show multiple views of a third exemplary embodiment of a pullout guide according to the invention;

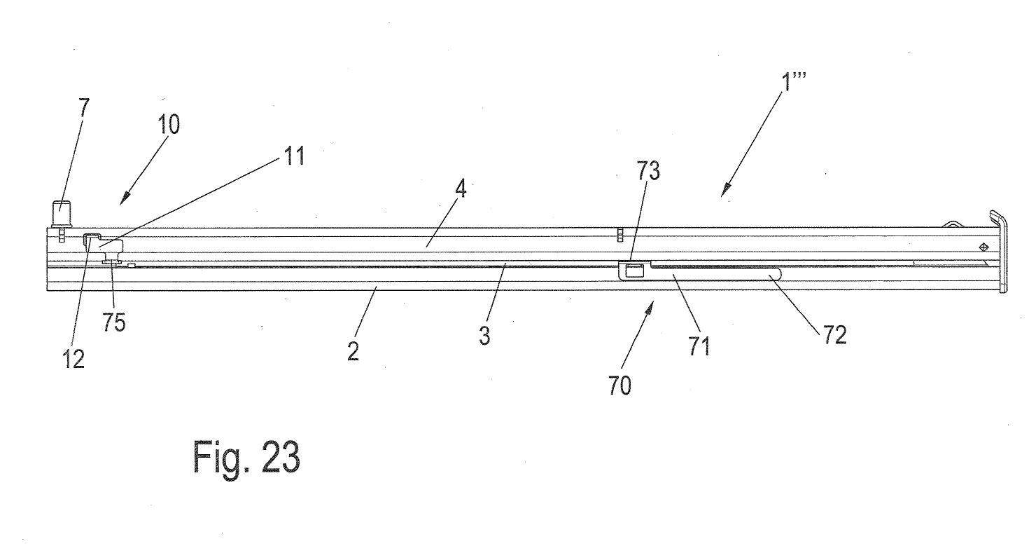

FIGS. 23 to 27 show multiple views of a fourth exemplary embodiment of a pullout guide according to the invention;

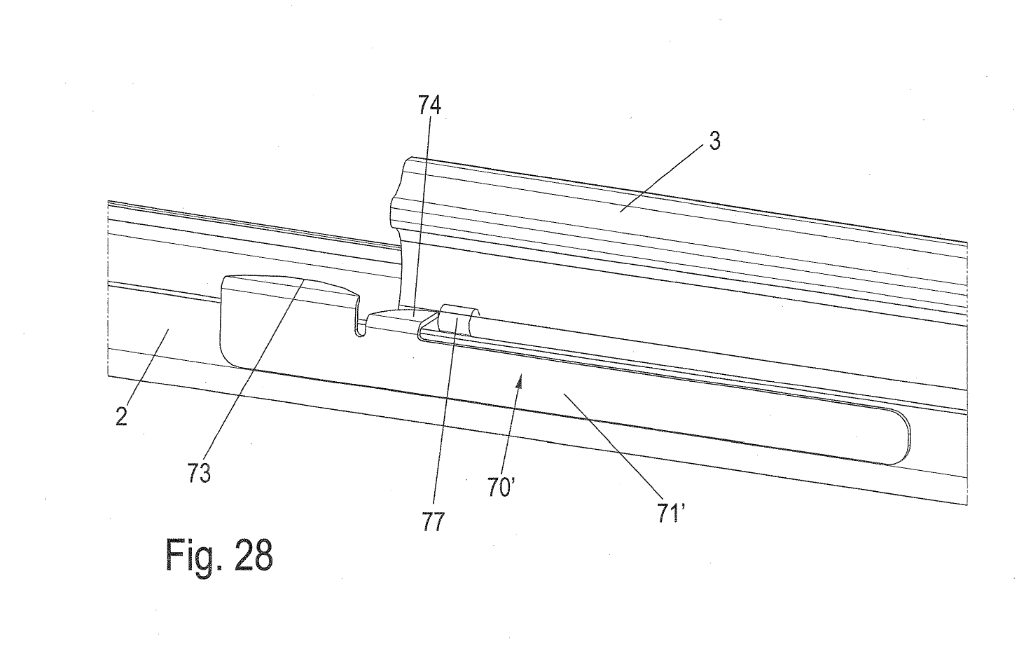

FIGS. 28 to 30 show multiple views of an exemplary embodiment, which is altered from the fourth exemplary embodiment, of a pullout guide according to the invention;

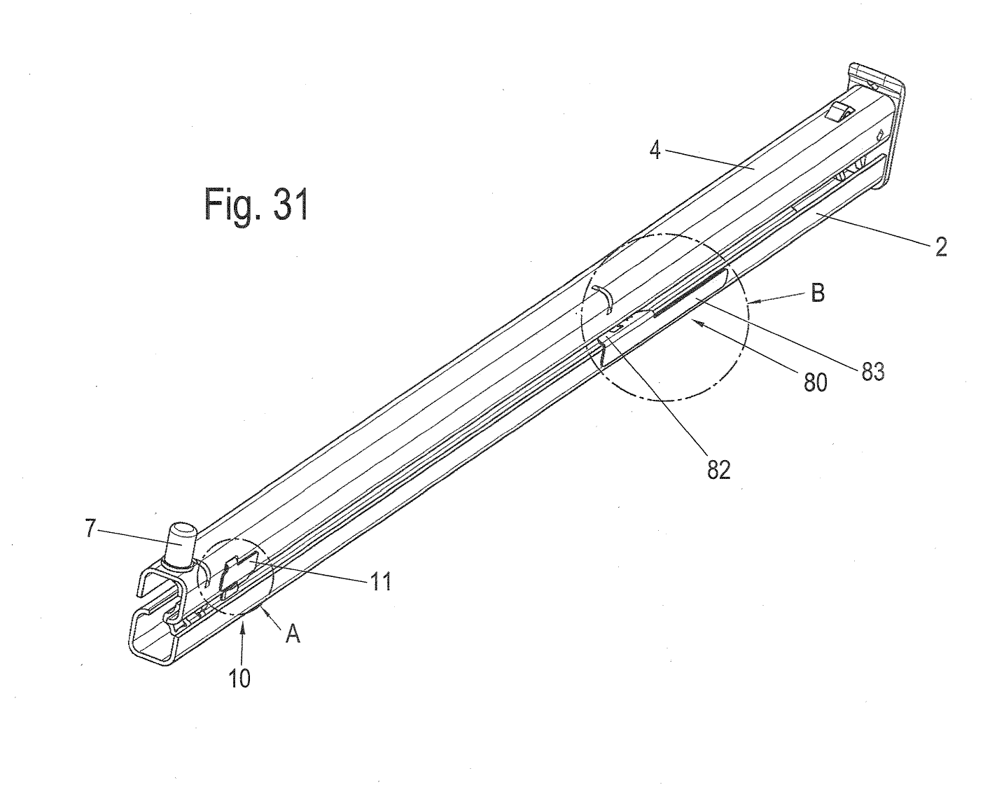

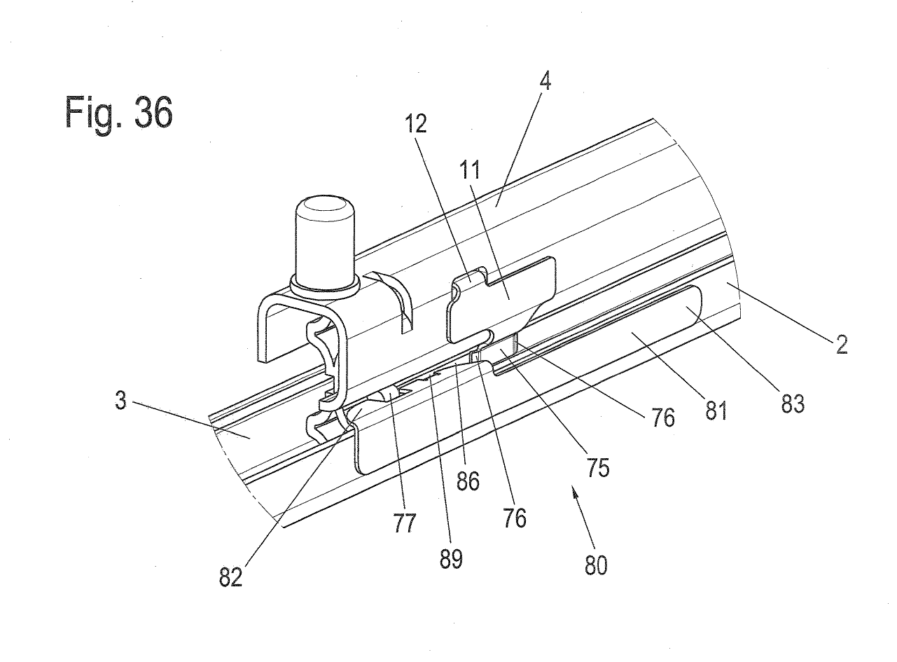

FIGS. 31 to 37 show multiple views of a fifth exemplary embodiment of a pullout guide according to the invention;

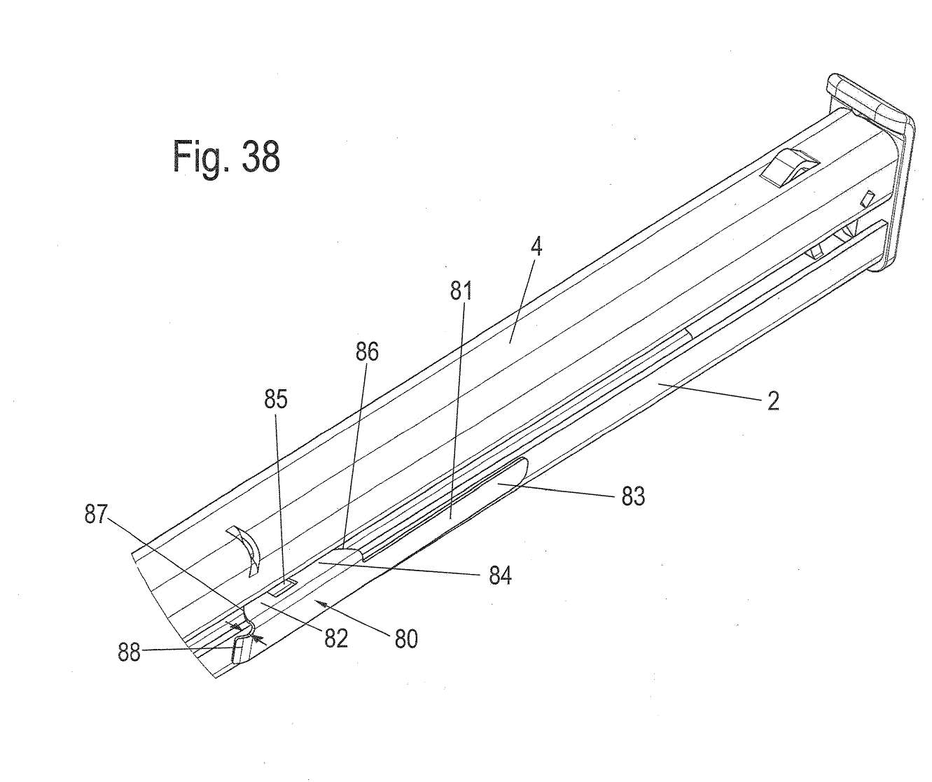

FIGS. 38 to 40 show multiple views of alterations of the fifth exemplary embodiment;

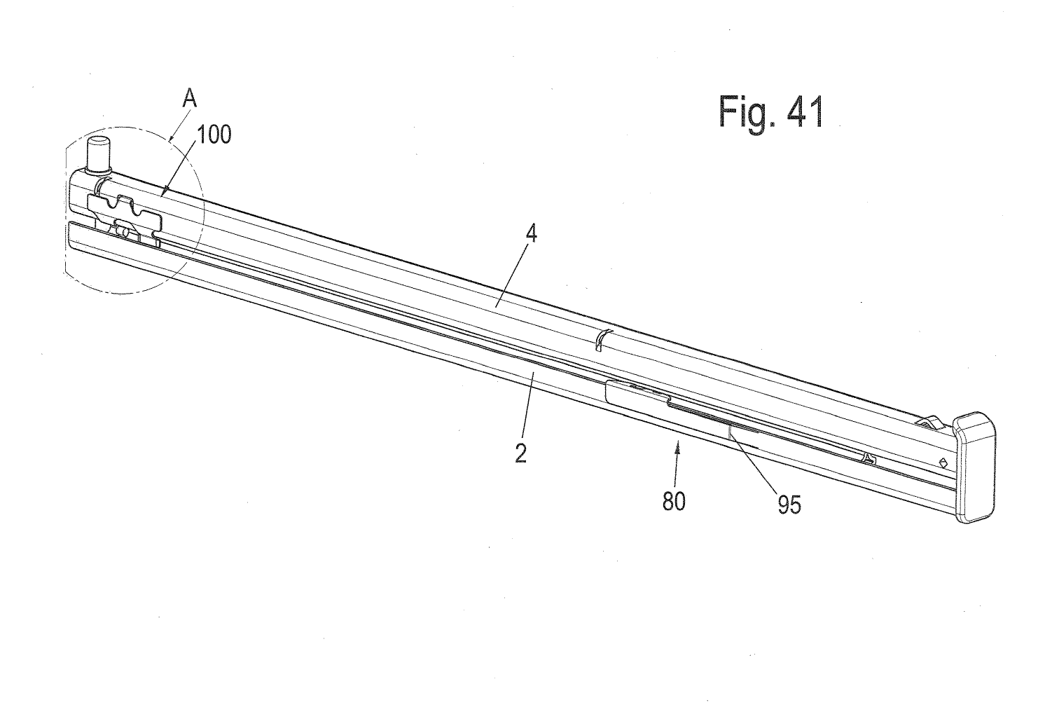

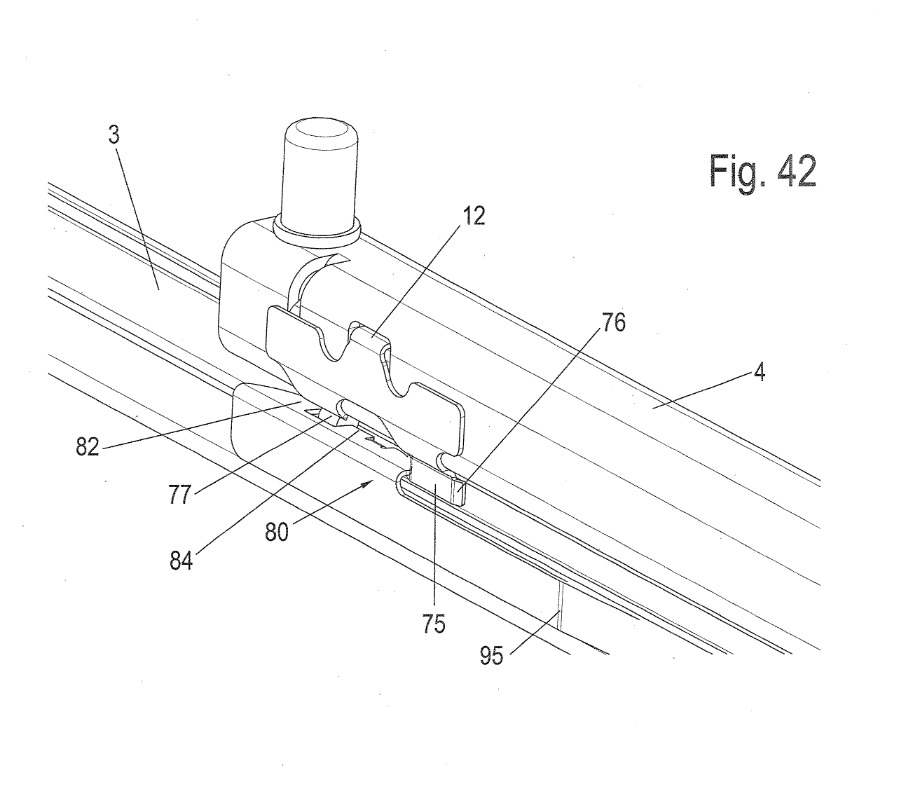

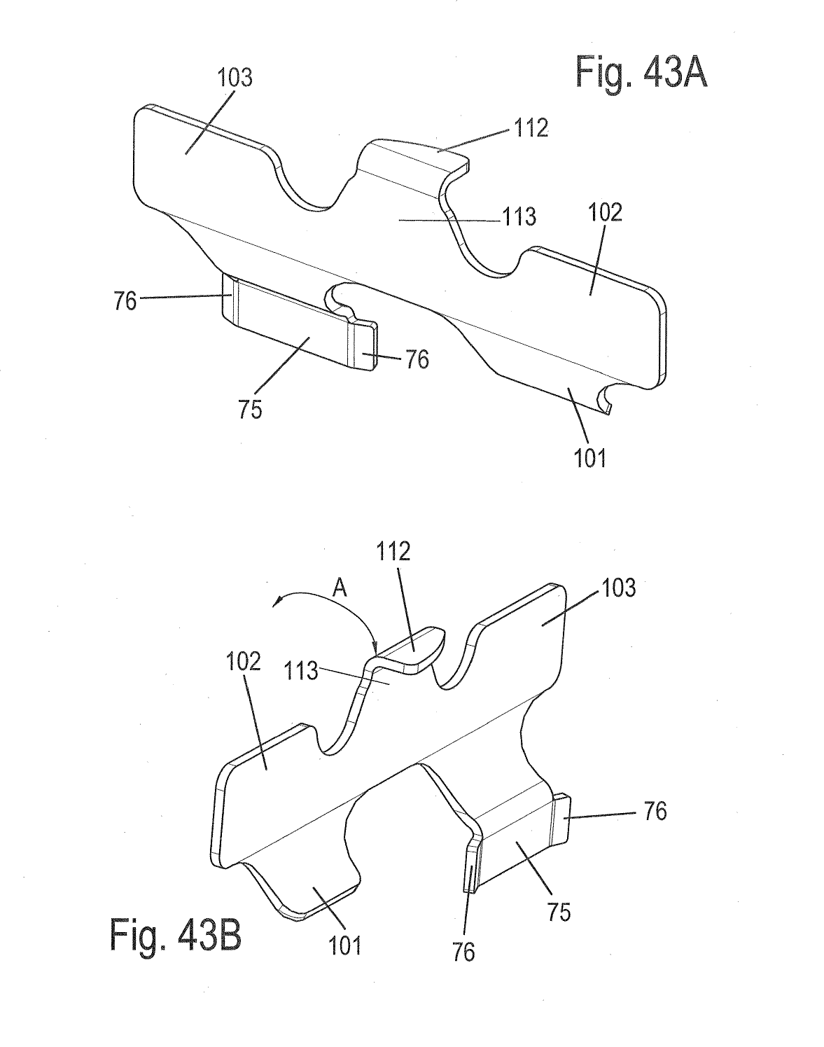

FIGS. 41 to 43 show multiple views of a sixth exemplary embodiment of a pullout guide according to the invention;

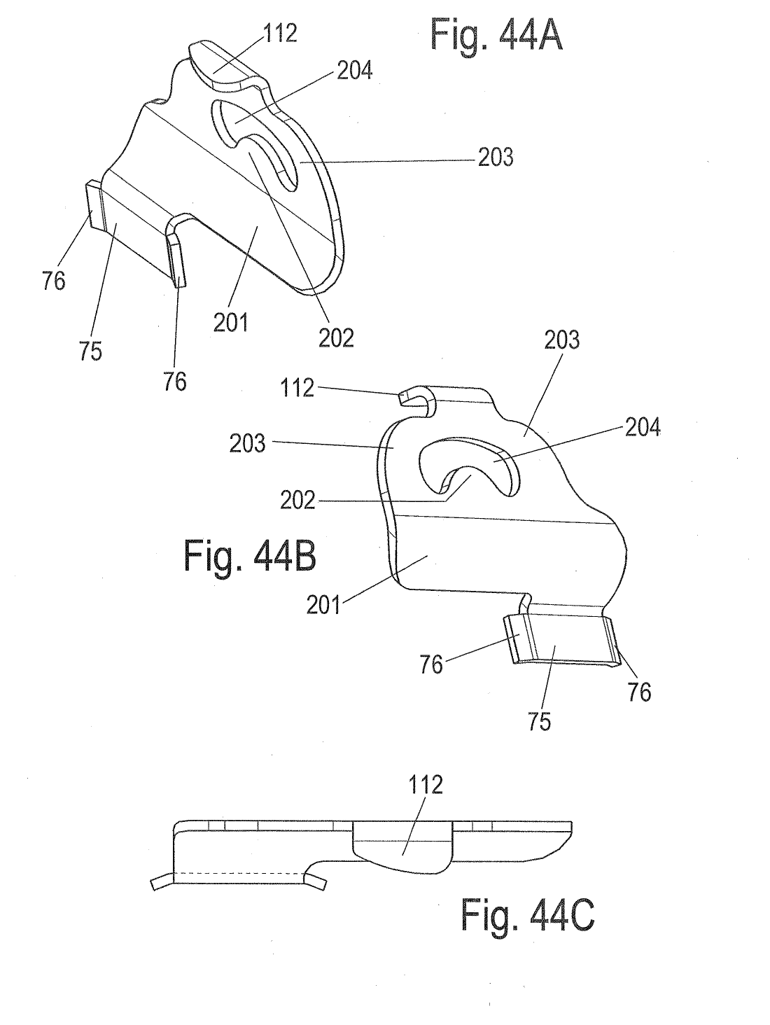

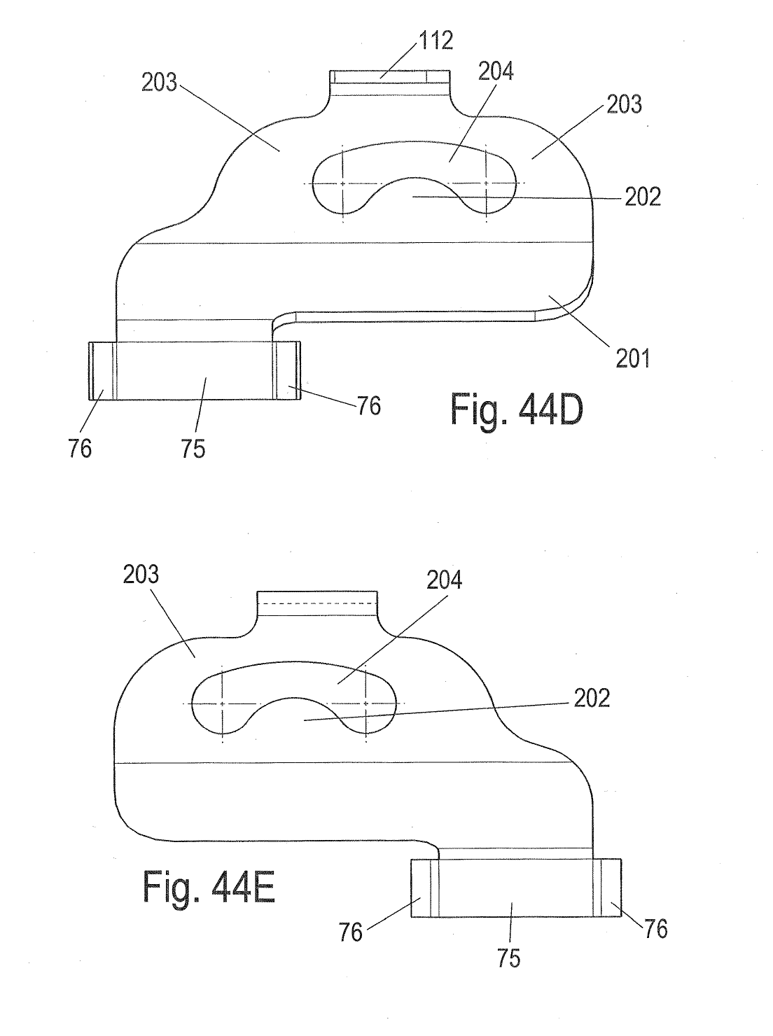

FIGS. 44A to 44E show multiple views of a seventh exemplary embodiment.

A pullout guide 1 comprises a rail 2, which can be fixed on a body of a piece of furniture or a domestic appliance, and which is usually arranged in a stationary manner, a rail 3, which is implemented as a middle rail, and a rail 4, which is also referred to as a slide rail, on which thrust elements, such as drawers, cooked material carriers, or other components are mounted so they are movable.

As shown in FIG. 2, a catch mechanism 10 having a bendable spring element 11, which engages through an opening 13 in the first rail 4 with a projection 12, is located on the first rail 4. Furthermore, a locking mechanism 20 is provided, which acts between the second rail 3 and the third rail 2. Of course, it is also possible to arrange the catch mechanism 10 on the second rail 3 or the third rail 2 and to provide the locking mechanism on the first rail 4. Only the exemplary embodiments shown are explained hereafter, wherein it is also possible to change the position and the arrangement of the respective catch mechanism and/or locking mechanism, depending on which structural specifications exist for the respective pullout guide.

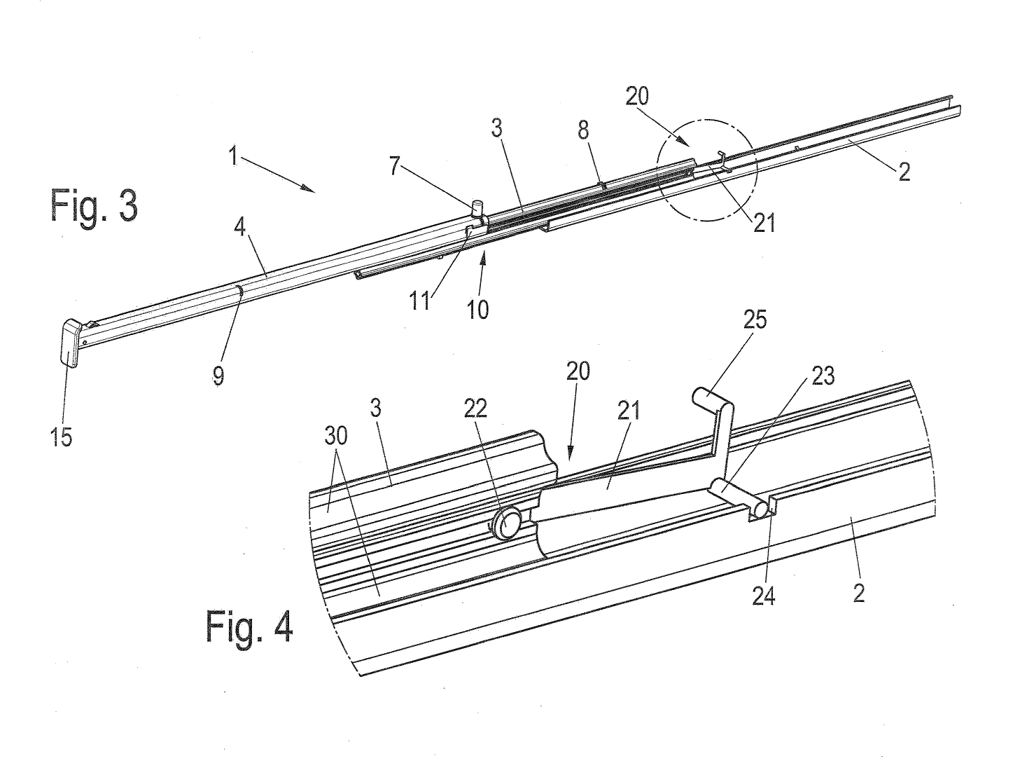

The pullout guide 1 is shown in a pulled-out position in FIG. 3. A plug 7, which protrudes upward on the first rail 4, is used for mounting a thrust element, for example, a cooked material carrier, while a plate 15 is fixed on the first rail 4 on the opposing front side. Embossed areas or profiles 8 are provided on the middle second rail 3, which are used as a stop for a roller body cage, which is arranged between the first rail 4 and the second rail 3. A further embossed area 9 is located on the first rail 4, which also forms a stop for the roller body cage. Further embodiments or stops are provided, but are not shown. The catch mechanism 10 is provided in the rear region of the first rail 4, while the locking mechanism 20 is arranged in the rear region of the second rail 3.

FIG. 4 shows the locking mechanism 20, which is active in particular in the pulled-out position, like the catch mechanism 10. The locking mechanism 20 comprises a lever 21, which is mounted so it is pivotable, and which is mounted so it is rotatable with an axis 22 in a middle region of the second rail 3, wherein the axis 22 is arranged adjacent to a rear end of the second rail 3. A laterally protruding projection 23 is arranged on the lever 21, which engages in a recess 24 on the third rail 2 in the locked position. Furthermore, a further projection 25 is implemented on the opposing side, which is used for unlocking the locking mechanism 20. In the locking position, the second rail 3 cannot be moved in relation to the third rail 2, since the projection 23 is held in the receptacle 24.

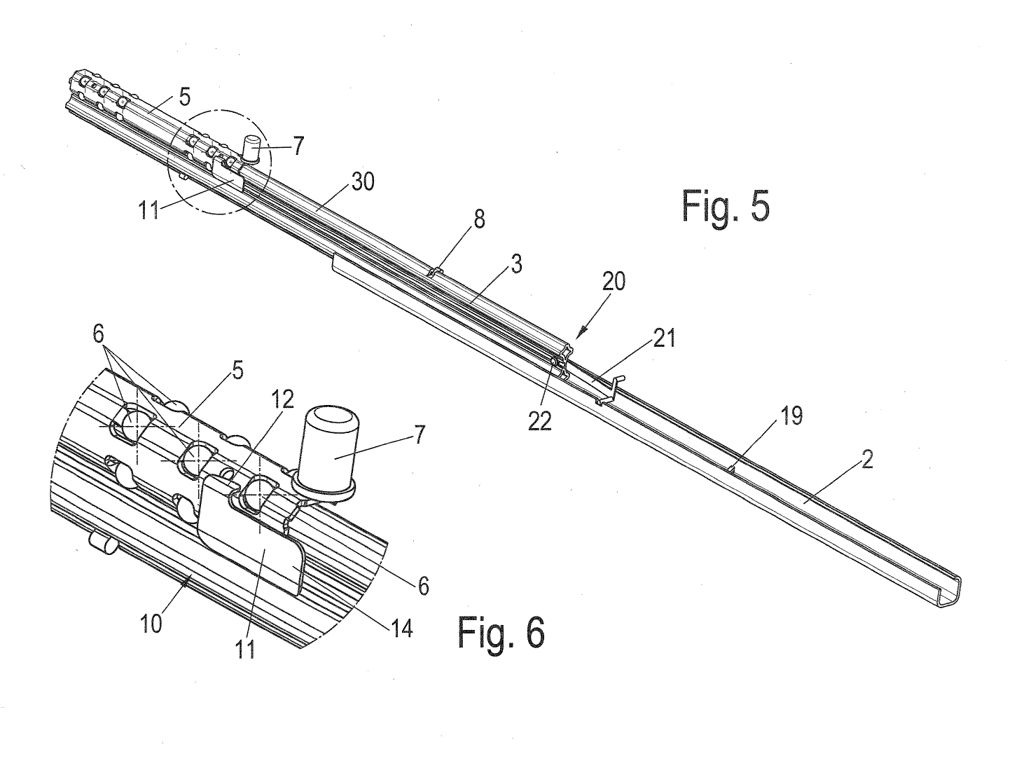

FIGS. 5 and 6 show the pullout guide 1 in the pulled-out position, in which both the locking mechanism 20 and also the catch mechanism 10 are active, wherein the first rail 4 was omitted for the illustration. The spring element 11 fixed on the first rail 4 is fixed with an end section 14 on the first rail 4 (not shown) and, on the opposite side, a projection 12 protrudes inward and presses there against a roller body cage 5 behind a spherical roller body 6. During the movement of the first rail 4, the roller body cage 5 is moved with the roller bodies 6 along the second rail 3 and the first rail 4 until the rearmost roller body 6 deflects the bendable spring element 11 outward and the projection 12 then latches behind the first roller body 6. To disengage the catch mechanism 10 from the catch position, the first rail 4 must now be moved back in the closing direction, whereby the projection 12 is deflected outward by the rearmost roller body 6, against the force of the spring element 11. Due to the comparatively exact guiding of the roller body 6 between the first rail 4 and the second rail 3, the deflection of the spring element 11 is exactly defined during the latching or unlatching, so that the catch forces can be set accordingly. Of course, it is also possible, instead of latching the spring element 11 on a roller body 6, to also perform latching on a projection or a recess on the roller body cage 5. Runways 30 for roller bodies 6 are provided on the rail 3.

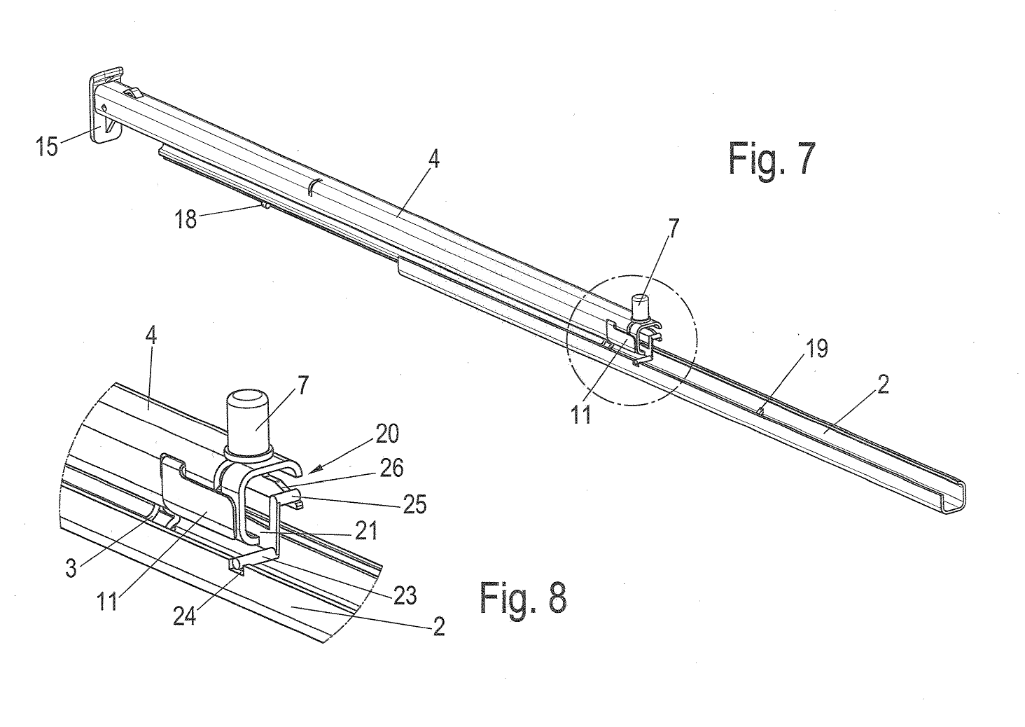

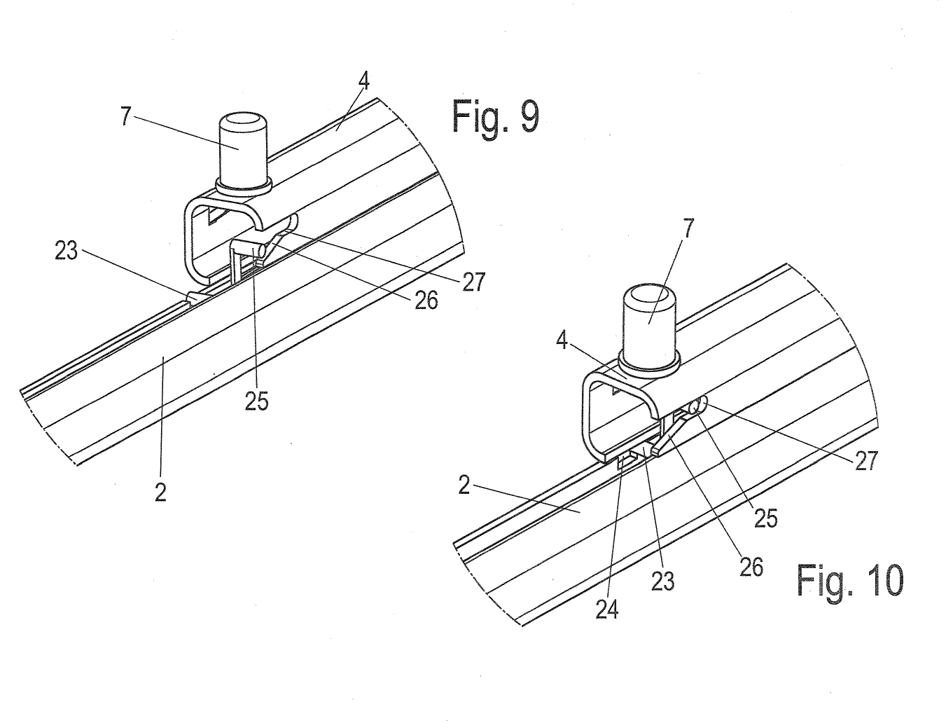

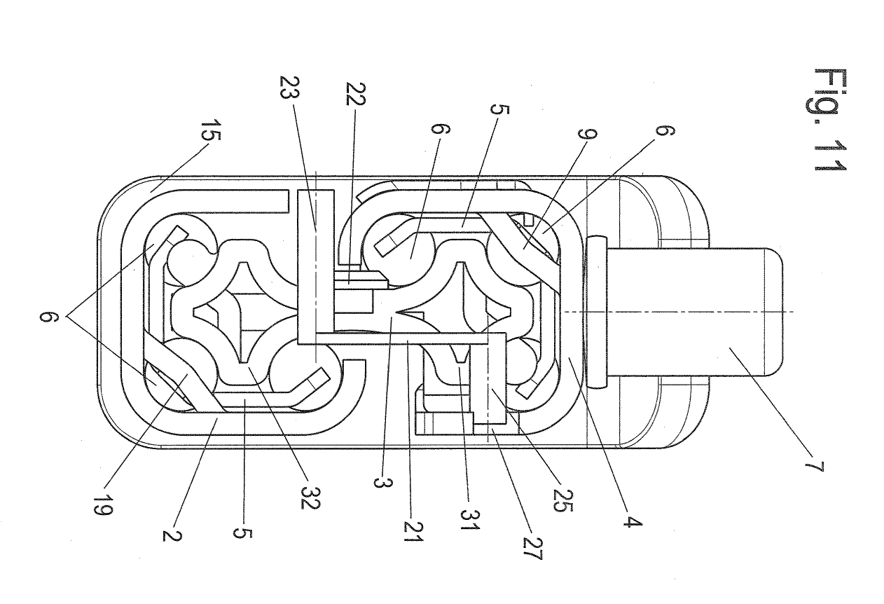

To move the pullout guide 1 back into the retracted position, firstly the first rail 4 is moved in relation to the second rail 3, wherein the catch mechanism 10 disengages. The position shown in FIGS. 7 and 8 is then reached, in which the rear end of the first rail 4 approaches the locking mechanism 20. A recess, on which an intake bevel 26 for the projection 25 is arranged, is implemented on the rear side on the first rail 4. Due to a movement of the first rail 4 in the closing direction, the projection 25 is guided along the intake bevel 26, whereby the pivotable lever 21 is lifted. Due to the lifting of the lever 21, the projection 23 moves out of the recess 24 and the locking mechanism 20 is unlocked. While the projection 25 is still guided along the intake bevel 26 in FIG. 9, the position is shown in FIG. 10 in which the pin-shaped projection 25 is held in a slotted horizontal receptacle 27 of the first rail 4. In this position, the locking mechanism 20 is located in the unlocked position and the projection 23 is arranged above the recess 24. The second rail 3 can thus now be moved in relation to the third rail 2, until the first rail 4 is arranged in the retracted position. The retracted position can be specified, for example, by stops in the form of profiles 8, 9 and 18, 19.

FIG. 11 shows a rear side view of the pullout guide 1, in which the projection 23 of the locking mechanism 20 is shown in the lifted position, wherein the projection 25 arranged on the opposing side is held on the receptacle 27. The second rail 3 has two sections 31 and 32, which are cross-shaped in cross section, and on each of which three curved runways for spherical roller bodies 6 are implemented. The roller bodies 6 are held in this case on a roller body cage 5, the movement of which is limited by profiles 9 or 19 in the longitudinal direction of the rails 2, 3, and 4.

In the following exemplary embodiments, the same reference signs are used for identical components, wherein essentially only the modified components are explained in their function hereafter.

In the exemplary embodiment shown in FIG. 12 of a pullout guide 1′, a catch mechanism 10 is provided, which is implemented as in the first exemplary embodiment.

However, a modified locking mechanism 40 is provided between the second rail 3 and the third rail 2.

FIG. 13 shows the pullout guide 1′ with the locking mechanism 40, which comprises a bendable spring web 41, which engages through the third rail 2 with a projection 42. On the side facing away from the projection 42, a fastening section 43 is provided, on which the spring web 41 is fixed on an outer side of the third rail 2, for example, by welding or gluing. A roller body cage 5 having a plurality of roller bodies 6 is provided between the third rail 2 and the second rail 3, wherein a recess 44 of the locking mechanism is arranged in the roller body cage 5.

A roller body cage 5 having a plurality of roller bodies 6 is also located between the first rail 4 and the second rail 3, wherein an unlocking element 45 for unlocking the locking mechanism 40 is implemented integrally with the roller body cage 5.

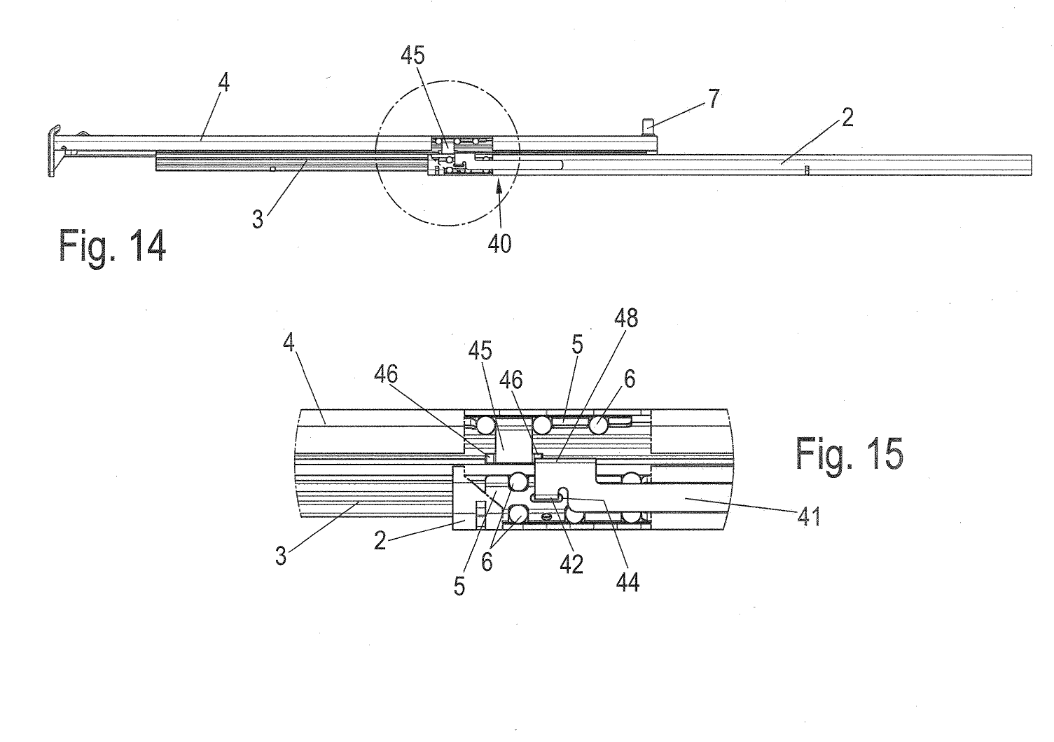

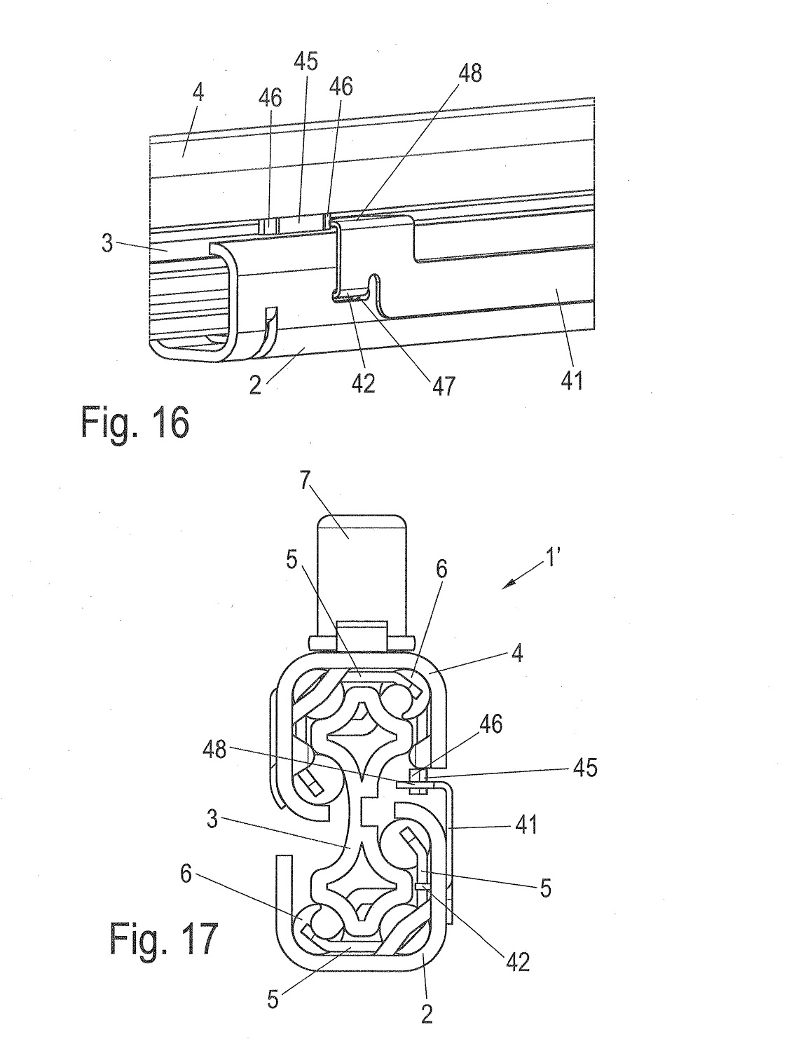

FIGS. 14 and 15 show the locking mechanism 40 in a locked position, while the catch mechanism 10 has already been disengaged and the first rail 4 has been moved in the closing direction. The unlocking element 45 on the roller body cage 5 is now located adjacent to the spring web 41, wherein intake bevels 46 are implemented on the unlocking element 45, which are used for the purpose of moving the spring web 41 outward, to move the projection 42 out of the recess 44 on the roller body cage 5. The unlocking element 45 acts in this case on an actuating section 48, which is implemented integrally with the spring web 41. As can be seen in the enlarged view of FIG. 16, the actuating section 48 is located with an angled projection between the first rail 4 and the third rail 2 and can therefore be engaged with the intake bevels 46 of the unlocking element 45. During the passage over the unlocking element 45, the projection 42 is briefly moved out of the recess 44 in the roller body cage 5, so that then the second rail 3 can be moved in the closing direction in relation to the third rail 2. An opening 47 for the passage of the projection 42 is provided on the rail 4.

FIG. 17 shows the pullout guide 1′ in a rear side view, wherein it can be seen that the inwardly oriented actuating section 48 is pressed outward as it passes over the unlocking element 45, whereby the projection 42 simultaneously moves out of the recess in the roller body cage 5. Simultaneously, the roller body cage 5 can be moved freely or moved by a profile on the second rail 3 in the closing direction.

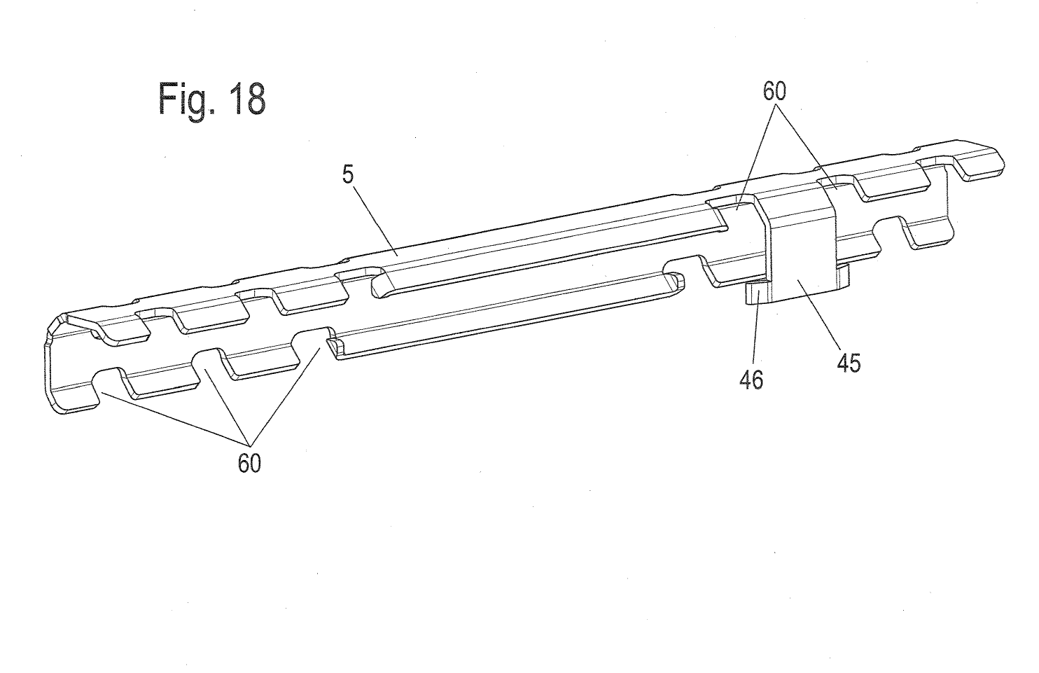

FIG. 18 shows the roller body cage 5, which is arranged between the first rail 4 and the second rail 3. A plurality of pockets 60 for receiving a spherical roller body are implemented on the roller body cage 5. Furthermore, a downwardly protruding web-shaped unlocking element 45 is provided, on which the intake bevels 46 are formed.

FIG. 19 shows a further exemplary embodiment of a pullout guide 1″, in which the catch mechanism 10 is implemented as in the first exemplary embodiment. Furthermore, a roller body cage 5, which has an unlocking element 45 having intake bevels 46, as is also shown in FIG. 18, is arranged between the first rail 4 and the second rail 3.

The pullout guide 1″ comprises a modified locking mechanism 50, which is attached on the outside on the third rail 2. The locking mechanism 50 comprises a bendable spring element 51, which has a projection 52 on one side, which engages through an opening 53 in the third rail 2 and has a clamp-type section 54 on the rear end, which is arranged adjacent to a plate 15 of the pullout guide 1″, another arrangement is also conceivable.

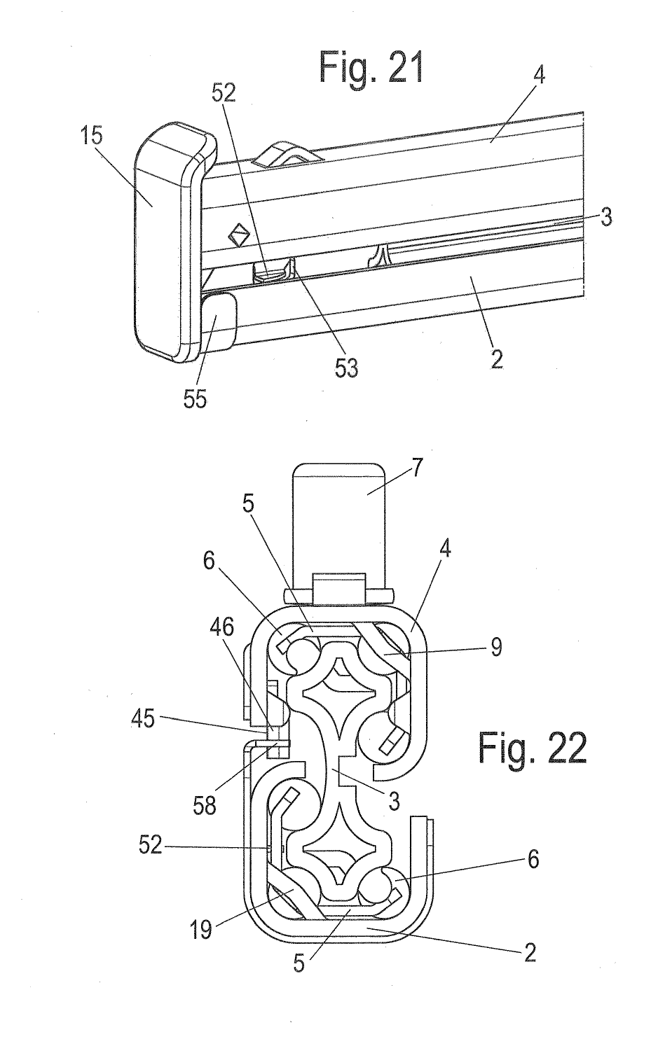

The clamp-type section 54 encloses the third rail 2 in a U-shape and can be fixed by welding or gluing on the third rail 2. An actuating section 58, which is movable via the unlocking element 45, is implemented on the spring element 51 above the projection 52. As in FIG. 21, the recess 53 in the third rail 2 is shown, through which the projection 52 engages. Furthermore, one end 55 of the clamp-type section 54 is shown, which encloses the rail 2 in a U-shape. It is also conceivable that instead of the clamp-type section 54, an angled L-shaped region or region shaped in another manner presses against or encloses the rail.

As can be seen in FIG. 22, the unlocking element 45 having the intake bevels 46 is located in a region of the actuating section 58, so that when passing over the unlocking element 45, the actuating section 58 is pressed outward, whereby the projection 52 is also moved out of a recess in the roller body cage 5 between the second rail 3 and the third rail 2. The locking mechanism 50 can thus be unlocked, so that the second rail 3 can then be moved in relation to the third rail 2.

FIG. 23 shows a fourth exemplary embodiment of a pullout guide 1′″, in which the rails 2, 3, and 4 are shown in a retracted position. The pullout guide 1″ comprises a catch mechanism 10, which is implemented as in the preceding exemplary embodiments, but additionally has an unlocking element 75, which protrudes downward from the spring web 11. Furthermore, a modified locking mechanism 70 is provided, which has an oblong spring web 71, which is fixed with an end section 72 on the third rail 2. The spring web 71 is aligned in parallel to the longitudinal direction of the third rail 2 and can be bent outward in the region of a projection 74. Instead of an oblong spring web 71, a clamp-type locking mechanism as already described is also conceivable here.

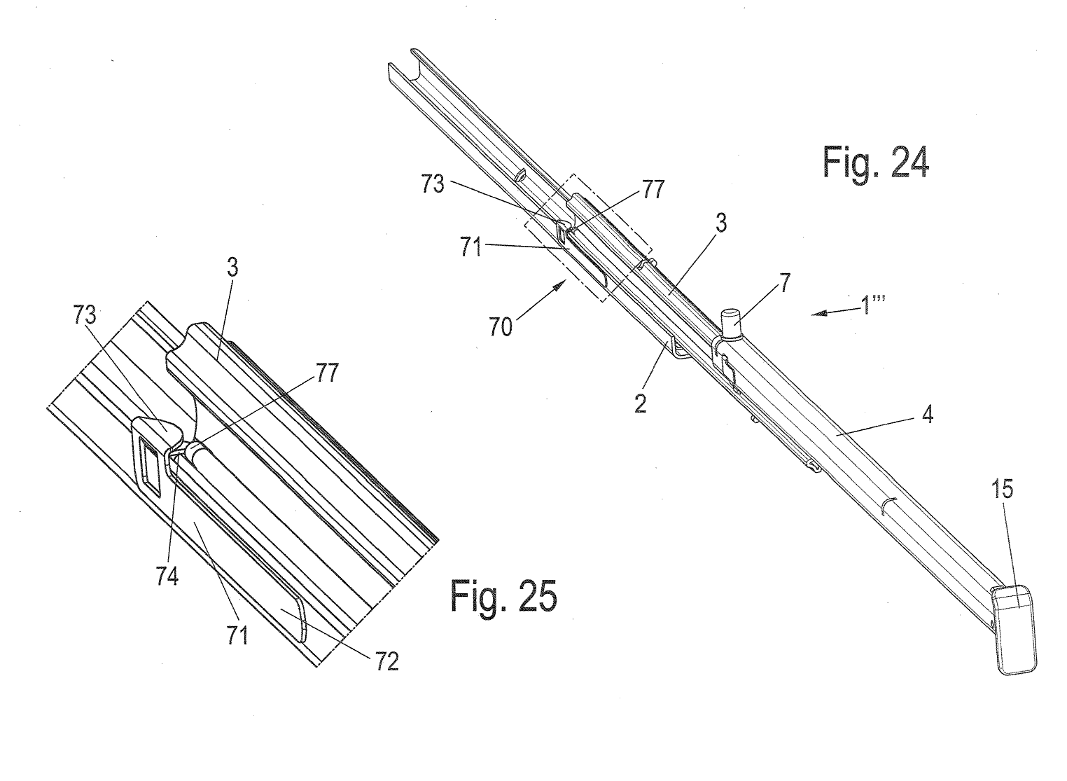

FIGS. 24 and 25 show the locking mechanism in detail, wherein the pullout guide 1″ is located in a pulled-out position, in which the locking mechanism 70 is active. The locking mechanism 70 comprises an actuating section 73, which is arranged adjacent to a projection 74. The actuating section 73 and the projection 74 are produced by stamping and bending and are located at different heights. The projection 74 forms the actual locking element, which presses against an embossed area 77 of the second rail 3, as shown in FIG. 25. This prevents the second rail 3 from moving in the closing direction when the locking mechanism 70 is active.

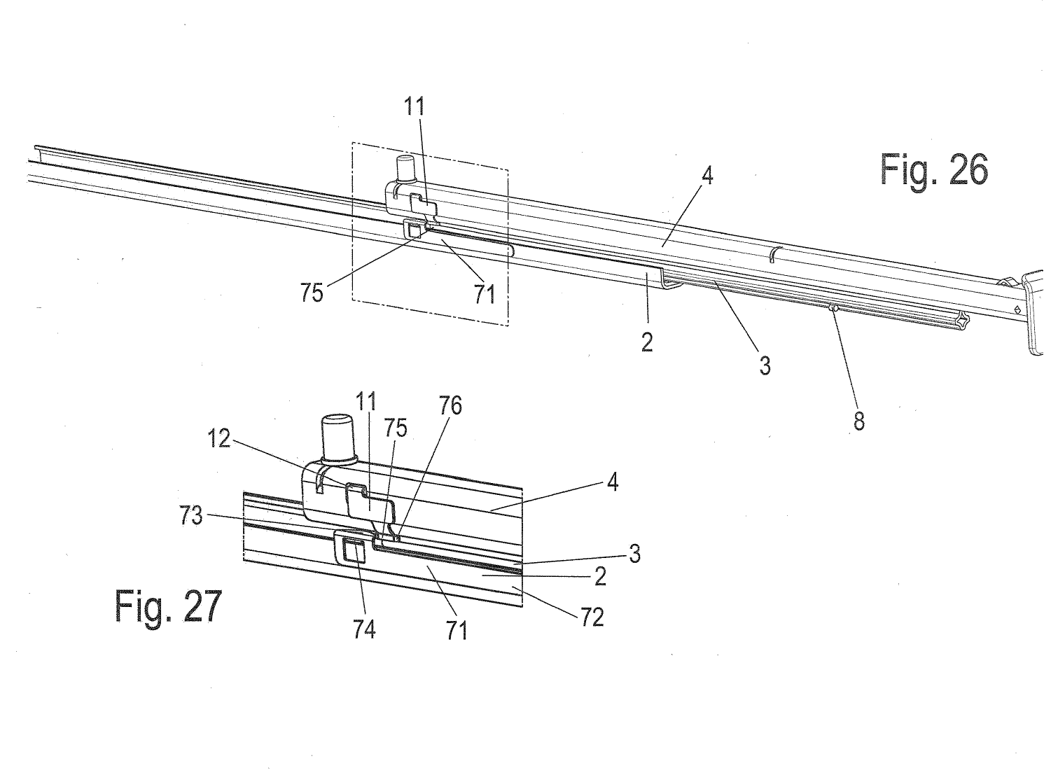

To unlock the locking mechanism 70, the first rail 4 is moved in the closing direction until the position shown in FIGS. 26 and 27 is reached. In this position, the unlocking element 75 with the intake bevels 76 engages on the actuating section 73, which is thus pressed outward during a movement of the third rail 4 in the closing direction, so that the projection 74 disengages from the embossed area 77 on the second rail 3. The blockade of the second rail 3 in the closing direction is thus canceled and the second rail 3 can now be moved in the closing direction, wherein the actuating section 73, after passing over the second intake bevels 76, enables a movement of the projection 74 inward, wherein then the embossed area 77 is already arranged on the opposite side of the projection 74.

FIGS. 28 to 30 show a modified embodiment, in which the actuating section 73 and the projection 74 are not arranged one over another, as in FIG. 27, but rather adjacent to one another, wherein a modified locking mechanism 70′ is provided, on which a spring web 71′ having an integrally implemented projection 74 and an integrally implemented actuating section 73 are provided, which act in the function as in the preceding exemplary embodiments, however. During the movement of the first rail 4 in the closing direction, an unlocking element 75 implemented on the spring web, and having intake bevels, causes a movement of the actuating section 73 outward, whereby the projection 74 disengages from the embossed area 77 on the second rail 3. The blockade of the middle second rail 3 is thus canceled and the pullout guide can be moved completely into the retracted position.

In the illustrated exemplary embodiments, a catch mechanism 10 is located in each case between the movable first rail 4 and the middle second rail 3. The locking mechanism is arranged between the second rail 3 and the rail 2 which can be fixed on a body. Of course, it is also possible to arrange the catch mechanism 10 between the rail which can be fixed on the body and the middle second rail 3, and to provide the locking mechanism in each case between the second rail 3 and the movable rail 4.

FIGS. 31 to 37 show a further exemplary embodiment of a pullout guide, in which a catch mechanism 10 is provided on three rails 2, 3, and 4, which is implemented as in

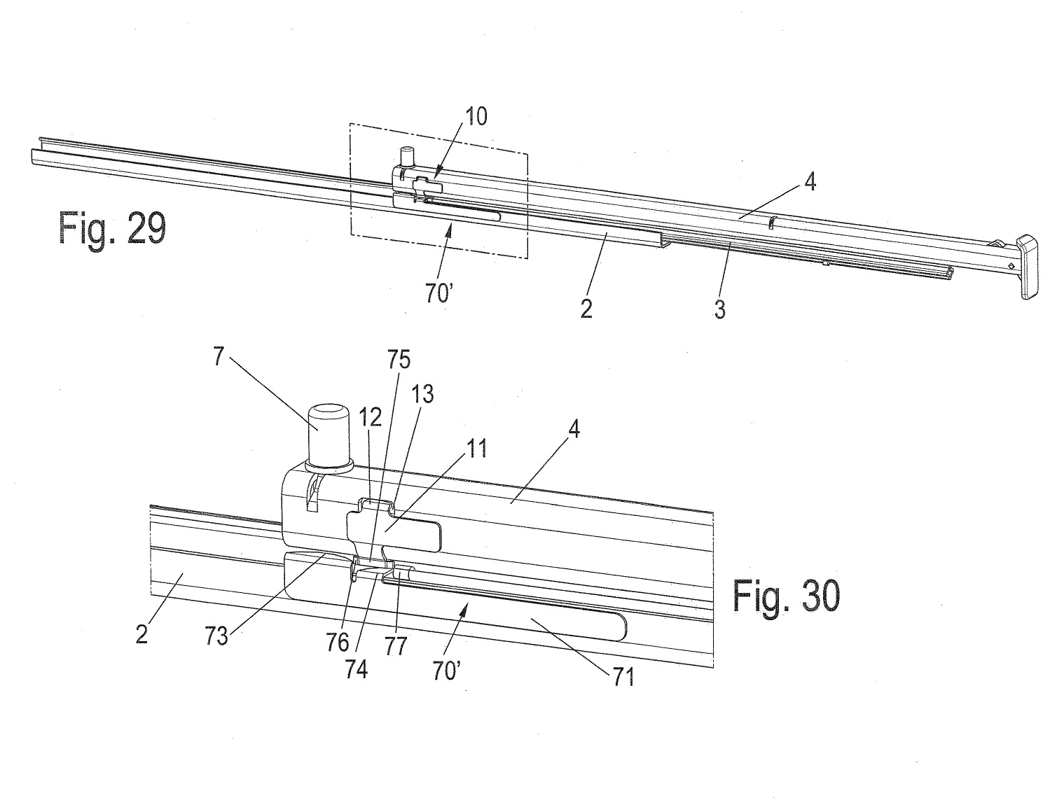

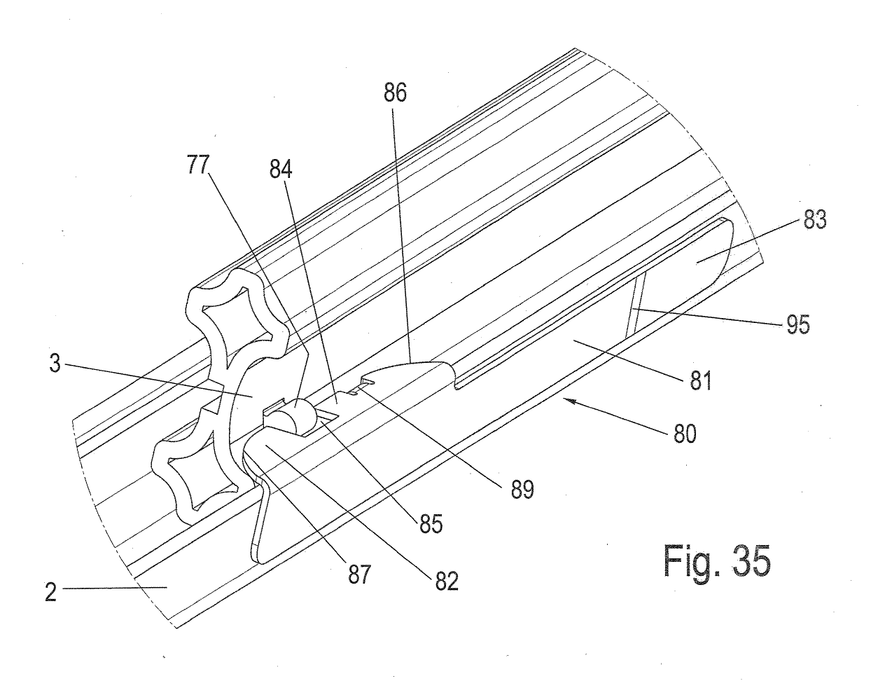

FIG. 30 and has, in addition to the bendable spring element 11 and the projection 12, an unlocking element 75 having an intake bevel 76. A locking mechanism 80, which has a bendable spring web 81, which has a fastening section 83 on one end and a projection 82 spaced apart from the fastening section 83, is arranged spaced apart from the catch mechanism 10. As shown in particular in FIG. 35, the fastening section 83 has a narrow folded edge 95 transversely to the rail 2, which is used for pre-tension, to ensure a secure contact of the spring web 81 and the rear locking spring end after they are welded on, and therefore to prevent undesired bending. FIG. 31 shows the pullout guide in a retracted position in this case.

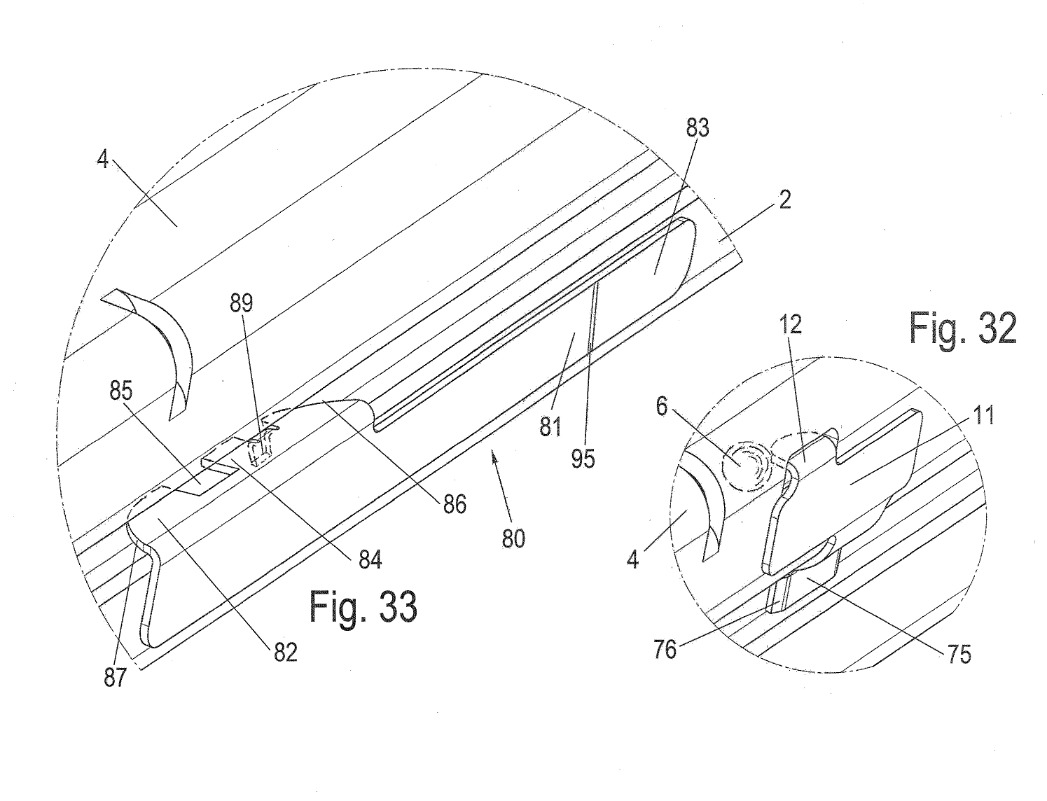

As is visible from the enlarged detail view of FIG. 32, the catch mechanism engages with the projection 12 behind a roller body 6, which is implemented as a ball, and therefore latches the rail 4 on the rail 3.

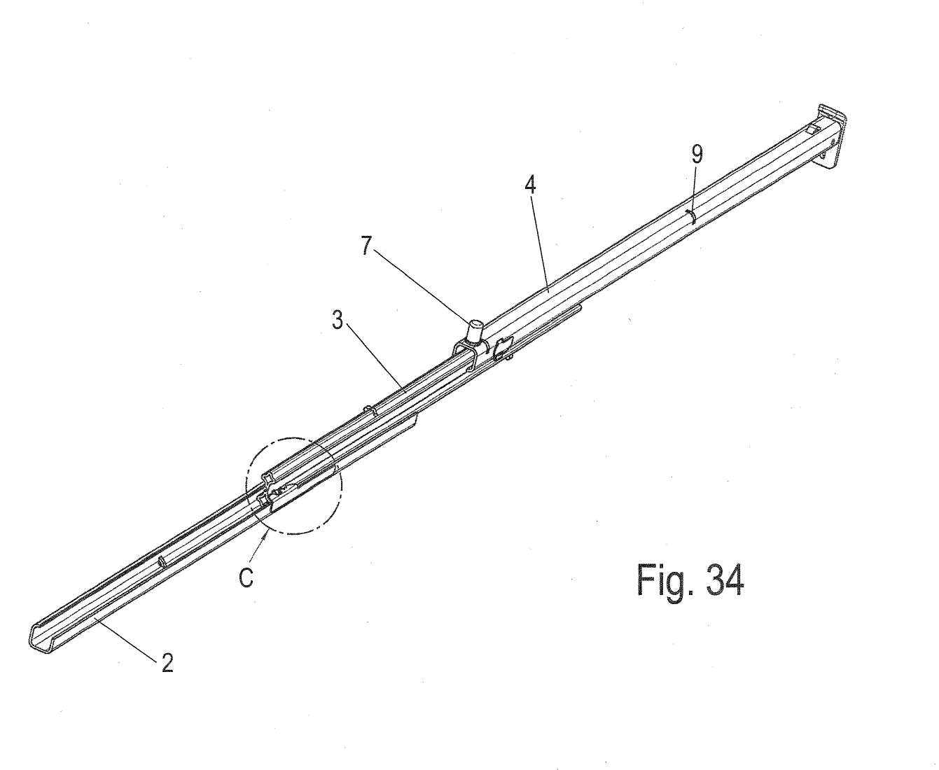

FIG. 33 shows the locking mechanism, which is fixed on the rail 2. A projection 82 is implemented on the bendable spring web 81, which protrudes essentially perpendicularly from the strip-shaped spring web 81 and engages between the rails 2 and 4. A recess 85 for receiving an embossed area 77 on the rail 3 is provided on the projection 82, this recess being enclosed by a further projection 84. Furthermore, a stop 89 is erected from the projection 82, which prevents the projection 82 from being deflected by more than a specific amount by the rail 2. For the unlocking operation, for example, the projection 82 is deflected between 2 mm and 6 mm, so that the stop 89 is used for the purpose of limiting the bending movement, to avoid plastic deformation of the bendable spring web 81. FIGS. 34 to 36 show the pullout guide in a pulled-out position, wherein the locking mechanism 80 is locked. For this purpose, an embossed area 77 on the rail 3 engages in the recess 85 between the projections 82 and 84. The rails 2 and 3 thus cannot be moved in relation to one another, while the rail 4 implemented as a slide rail can be moved into a retracted position after overcoming the catch forces. During a closing movement, the rail 4 then arrives at the locking mechanism 80, wherein intake bevels 86 and 87, which come into contact with the intake bevels 76 of the unlocking element 75, are implemented on the sides opposite to the projections 82 and 84, so that the projections 82 and 84 are moved outward by the rail 2, at most until the stop 89 limits the movement, and the embossed area 77 moves out of the recess 85, so that the rails 2 and 3 can be moved in relation to one another. The rail 3 can then subsequently also be moved in the closing direction.

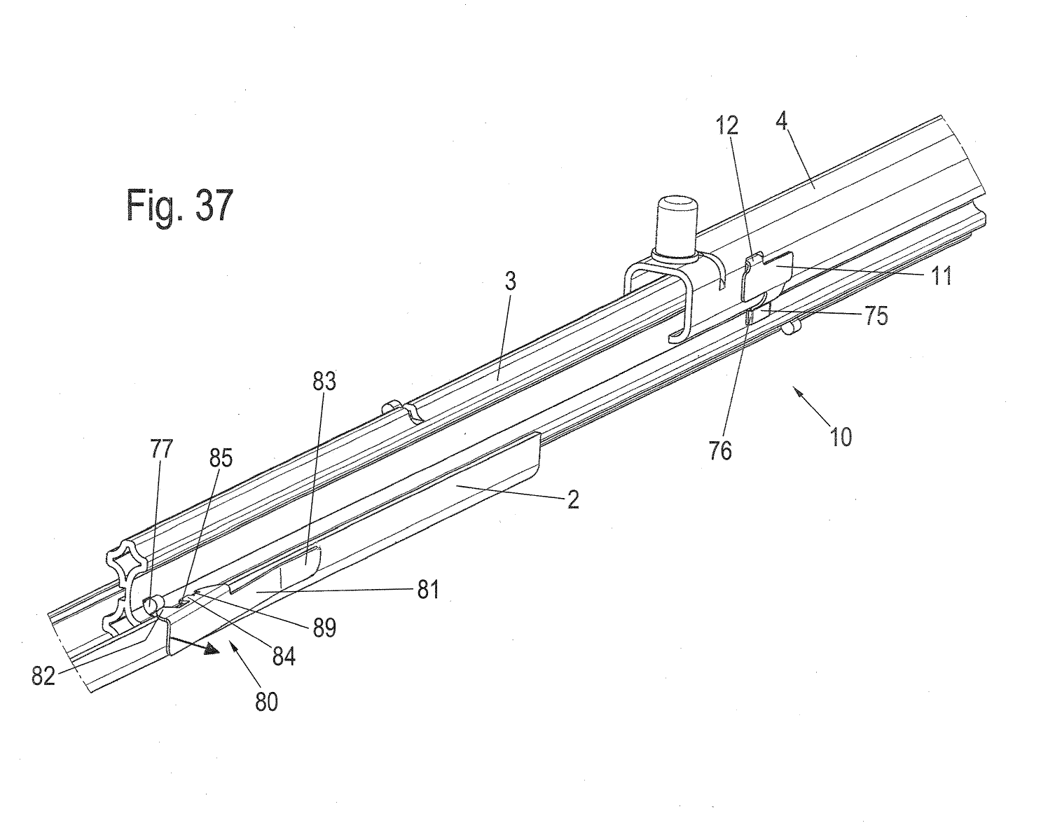

FIG. 37 shows the pullout guide during an extension movement of the rails 3 and 4, wherein, on the rail 3, the embossed area 77 presses against the intake bevel 87 of the projection 82, so that the spring web 81 is bent away from the rail 2 corresponding to the illustration of the arrow. The rail 3 can thus be moved further in the extension direction until the embossed area 77 engages in the recess 85 between the projections 82 and 84. The rails 2 and 3 are therefore locked against one another. To limit the bending movement outward, a stop 89 is implemented by an angled web on the projection 84, which prevents the spring web 81 from being moved away manually from the rail 2 farther than required for the unlocking operation or the latching operation.

FIG. 38 shows the pullout guide of FIGS. 31 to 37 with the locking mechanism 80, which has a bend 88 facing toward the rail 2 on the side opposite to the fastening section 83. A terminal edge of the bend 88 thus presses with a defined pre-tension against the rail 2, which is to prevent the spring web 81 from unintentionally being engaged behind during a cleaning operation and therefore bent away from the rail 2.

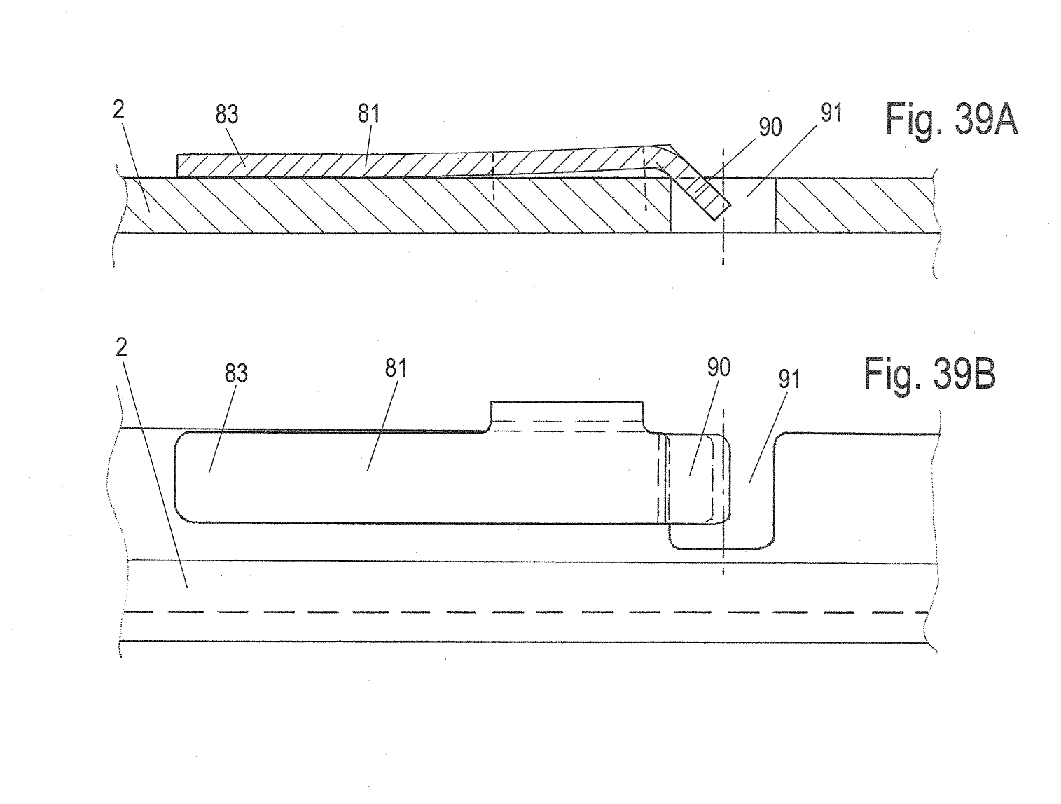

The lifting safeguard shown in FIG. 38 can be further improved according to FIGS. 39A and 39B in that an angled area 90 is arranged on the spring web 81 on the side opposite to the fastening section 83, which faces toward the rail 2 and engages therein in a recess 91 or a receptacle. The free end of the bendable spring web 81 is thus poorly accessible from the outside and cannot unintentionally be lifted. Depending on the positioning, a desired spring pre-tension can be set by contact of the angled area 90 on the front recess edge.

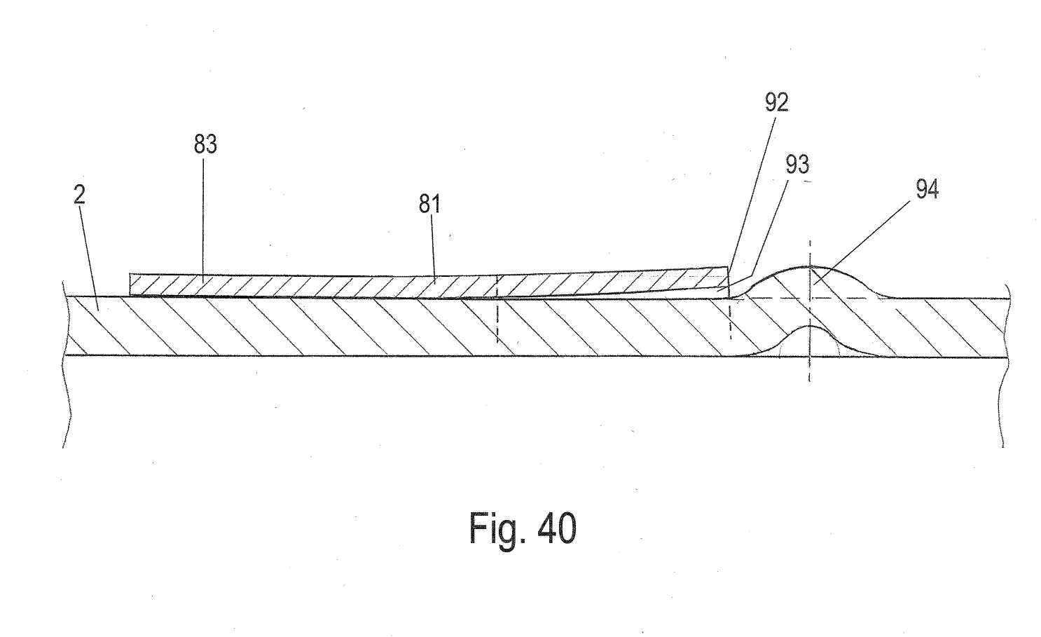

An alternative for the lifting safeguard is shown in FIG. 40. The bendable spring web 81 is overlapped by an end edge of an embossed area 94, which protrudes outward from the rail 2 and prevents a gap 93 between the end edge 92 and the rail 2 being engaged in unintentionally during cleaning.

FIGS. 41 to 43 show a sixth exemplary embodiment of a catch mechanism 100, which interacts with a locking mechanism 80, as was described above. The catch mechanism 100 is formed from a bendable metal plate, which is fixed at fastening sections 102 and 103 on the rail 4. An angled projection 112 is implemented in a middle region of the catch mechanism, which engages in an opening of the rail 4 and can be latched therein on a roller body 6 or a roller body cage. The projection 112 has intake bevels on opposing sides, to enable latching and disengagement of the latching. A spring web 113, which can be deflected transversely to the longitudinal direction of the rail 4, adjoins the projection 112. A deflection A of the bendable spring web is illustrated by an arrow, it occurs approximately 90° to the pullout direction. The spring direction therefore results transversely to the rail 4. A region 101 is used for supporting the spring web 113 and extends it on the side facing away from the projection 112. The spring rate can thus be increased, or the spring action can be embodied as softer. Furthermore, the region 101 offers tool advantages due to symmetry to the adjacent region during the manufacturing of left and right parts, wherein identical tools can be used over many process steps. Furthermore, more exact positioning of the component before it is welded on can be performed, the region 101 is therefore used as a positioning aid before the fastening on the rail 4. A plate-shaped section 103, which is connected to an unlocking element 75 having intake bevels 76 on opposing sides, is implemented on the side diametrically opposite to the region 101. The region 101 is not connected in this case to the rail 4, but rather presses freely thereon.

The above-described measures on the catch mechanism 100 in comparison to the above-described exemplary embodiment result in lengthening of the service life and reduction of the risk of incorrect operation or damage of the catch mechanism.

FIGS. 44A and 44E show a seventh exemplary embodiment of a catch mechanism 200, which interacts with a locking mechanism 80, as was already described above. Identical reference signs are used for already described regions having identical function. A region 201 comes into contact on the rail 4 and is used as a carrier for the intake bevels 76 and the unlocking element 75. The fixing of the catch mechanism 200 on the rail 4 is performed on a fastening section 202, preferably by welding. The fastening section 202 is enclosed by a relieving opening 204, which is implemented nearly in the form of a kidney or semicircle. The relieving opening 204 was dimensioned by ascertaining the tension curves within the catch mechanism. A spring web 203, which connects the fastening section 202 to the projection 112, is arranged in each case on both sides of the relieving opening. The projection 12 has a nearly kidney-shaped contour 114. A soft sequence of the latching or unlatching operation is ensured by the contour 114. Tension fractures are avoided due to the introduction and embodiment of the relieving opening 204.

In addition, a predetermined catch position in the completely extended position of the pullout guide 1, 1′, 1″, 1″′ is provided in the illustrated exemplary embodiments. Of course, it is also possible to provide the predetermined catch position at another position and/or to arrange multiple catch positions on the movement path of the pullout guide.

The pullout guides 1, 1′, 1″, 1′″ can be produced completely from metallic components, since both the catch mechanism and also the locking mechanism are preferably produced from stamped and bent metal plates. The pullout guides 1, 1′, 1″, 1″′ can thus preferably be used for domestic appliances, such as ovens, in particular they have a high temperature resistance. Usage for other fields, such as furniture, refrigerators, or other intended uses, is also possible.

### LIST OF REFERENCE NUMERALS

1, 1′, 1″, 1′″ pullout guide
2 rail
3 rail
4 rail
5 roller body cage
6 roller bodies
7 plug
8 embossed area
9 profile
10 catch mechanism
11 spring element
12 projection
13 opening
14 end section
15 plate
18 profile
19 profile
20 locking mechanism
21 lever
22 axis
23 projection
24 recess
25 projection
26 intake bevel
27 receptacle
30 runway
31 section
32 section
40 locking mechanism
41 spring web
42 projection
43 fastening section
44 recess
45 unlocking element
46 intake bevel
47 opening
48 actuating section
50 locking mechanism
51 spring element
52 projection
53 opening
54 section
55 end
50 actuating section
60 pocket
70, 70′locking mechanism
71 spring web
72 end section
73 actuating section
74 projection
75 unlocking element
76 intake bevel
77 embossed area
80 locking mechanism
81 spring web
82 projection
83 fastening section
84 projection
85 recess
86 intake bevel
87 intake bevel
88 bend
89 stop
90 angled area
91 recess
92 end edge
93 gap
94 embossed area
95 folded edge
100 catch mechanism
101 region
102 fastening section
103 fastening section
112 projection
113 spring web
114 contour
200 catch mechanism
201 region
202 fastening section
203 spring web
204 relieving opening
A deflection

1. A pullout guide for domestic appliances or furniture, having a first rail, a second rail and a third rail mounted to be movable in relation to one another, wherein the third rail is fixed on a body and the first rail is connected to a thrust element, and a catch mechanism, to latch the first rail in a predetermined position in relation to the second rail (3), wherein a locking mechanism is provided, to lock the second rail against a movement in relation to the third rail in the predetermined position.

2. The pullout guide according to claim 1, wherein the locking forces for locking the second rail in relation to the third rail are greater than the-catch forces of the catch mechanism for latching the first rail on the second rail.

3. The pullout guide according to claim 1, wherein an unlocking element is provided, to unlock the locking mechanism and enable a movement of the second rail in relation to the third rail.

4. The pullout guide according to claim 3, wherein the unlocking element is provided for the locking mechanism on the first rail.

5. The pullout guide according to claim 4, wherein the unlocking element is movable together with the first rail and a locking element is movable via the locking element essentially perpendicularly to the longitudinal direction of the rails.

6. The pullout guide according to claim 1, wherein the locking mechanism has a locking element, which engages on the second rail or the third rail.

7. The pullout guide according to claim 6, wherein the locking mechanism comprises a pivotable lever or a bent wire, which is insertable with a projection in a recess on the second rail or the third rail.

8. The pullout guide according to claim 1, wherein the locking mechanism has a locking element, which engages on a roller body cage or a roller body between the second rail or the third rail.

9. The pullout guide according to claim 3, wherein the locking element is implemented on a bendable spring web, which has an actuating section, on which the unlocking element can engage.

10. The pullout guide according to claim 9, wherein a stop is provided on the bendable spring web to limit the maximum deflection.

11. The pullout guide according to claim 9, wherein an end of a spring web, which can be lifted off of a rail, is implemented bent toward the first, second or third rail and engages in a receptacle or recess on the first, second or third rail.

12. The pullout guide according to claim 1, wherein the catch mechanism has a spring element, which is bent before reaching the predetermined position of the first rail and the second rail to then engage behind a catch means.

13. The pullout that according to claim 12, wherein the catch means is a roller body or a projection on a roller body cage.

14. The pullout guide according to claim 12, wherein the locking element of the locking mechanism, the spring element the catch mechanism or both is produced from a metal plate.

15. A pullout guide, wherein the pullout guide is used for displacing a cooked material carrier in an oven.
